(19) United States
(12) Patent Application Publication
(10) Pub. No.: US 2005/0203763 A1
(43) Pub. Date: Sep. 15, 2005

(54) Methods and apparatus for managing send jobs

(76) Inventors: Robert Sesek, Merridian, ID (US); Riyadth Al-Kazily, Star, ID (US); Chad Stevens, Boise, ID (US)

Correspondence Address: HEWLETT-PACKARD COMPANY;Intellectual Property Administration, P.O. Box 272400, Fort Collins, CO, 80527-2400, US

(21) Appl. No.: 10/866,855

(22) Filed: Jun. 12, 2004

Related U.S. Application Data
(63) Continuation of application No. 60/552,154, filed on Mar. 10, 2004.

(51) Int. Cl. G06F 17/60

(52) U.S. Cl. 705/1

(57) ABSTRACT

A system and method is directed to managing digital send jobs from a digital sender device. The method includes receiving at least one digitally scanned image from the digital sender device, generating a first digital send job responsive to receiving the at least one digitally scanned image, generating at least a first proof image based on the first digital send job, and communicating the first proof image to a printing device. A computer readable medium is described which includes computer executable code to direct the reception of at least one digitally scanned image from the digital sender device, to generate a first digital send job responsive to receiving at least one digitally scanned image, to generate at least a first proof image based on the first digital send job, and to communicate the first proof image to a printing device.

### CROSS REFERENCE TO RELATED APPLICATIONS

This application claims priority to U.S. Provisional Patent Application Ser. No. 60/552,154, filed Mar. 10, 2004, which is hereby incorporated by reference herein in its entirety.

### BACKGROUND

Digital sending devices are devices designed to send image data to recipients through a communication system, such as a network or the Internet. Conventional digital sending devices may incorporate several functions such as scanning, printing and communication capabilities, or may offer limited functionality such as scanning and communication. Many digital sending devices offer a limited user interface such as a keypad combined with a small alpha-numeric display. Such user interfaces are limited in functionality, and in some cases a communication-enabled digital sending device is used in combination with a connected component such as a computer having a display in order to provide a preview of a scanned image.

In order to communicate a digitally scanned image, a data file is created that contains the scanned image and other information, such as, for example, destination data and various communication protocol data. Typically, a user of a digital sending device enters one or more destination addresses through the user interface of the digital sending device. Once an image is scanned, it is frequently necessary to send the image file to another destination, such as a connected computer, in order to preview the outcome of the scanning process. Once received by a computer and verified, the image file may be forwarded to an intended recipient. However, such an image verification process undermines the advantage of a digital sending device designed to directly send images to recipients. Furthermore, when a scanning job involves tens, hundreds or even thousands of scanned documents, it is often valuable to determine whether a scanning job is correct in order to prevent wasted time and materials. It would be desirable therefore, to provide advancements to the art that overcome these and other disadvantages.

### SUMMARY

According to an embodiment of the present invention, a method is directed to managing digital send jobs from a digital sender device that includes receiving at least one digitally scanned image from the digital sender device, generating a first digital send job responsive to receiving the at least one digitally scanned image, generating at least a first proof image based on the first digital send job, and communicating the first proof image to a printing device.

According to another embodiment, a method is directed to modifying a digital send job based on user input to a digital sending device that includes generating a first digital send proof image based on the digital send job, retrieving a stored user input template image, and combining the first digital send proof image and the retrieved user input template image into a second digital send proof image. The method further includes printing the second digital send proof image, and receiving the user input from the digital sending device, wherein the second digital send proof image is scanned subsequent to incorporation of user input on the printed second digital send proof image. The method also includes determining the user input from the second digital send proof image, and modifying the digital send job based on the determined user input prior to sending the job.

According to still another embodiment, a scanner configured to operate as a user interface for modifying digital send jobs includes a digital scanning device including, a communication interface, a digital scanning apparatus, a processor, and a computer readable memory device which is readable by the processor. The computer readable memory device contains a series of computer executable steps configured to cause the processor to receive at least one digitally scanned image from the digital scanning apparatus, to generate a first digital send job responsive to receiving at least one digitally scanned image, to generate at least a first proof image based on the first digital send job, and, finally to communicate the first proof image to a separate printing device through the communication interface.

The foregoing and other features and advantages of the invention will become further apparent from the following detailed description of the presently preferred embodiments read in conjunction with the accompanying drawings.

### DESCRIPTION OF THE DRAWINGS

FIG. 1 is a block diagram of a networked digital sender system, illustrating an exemplary operating environment for an embodiment of the present invention.

FIG. 2 illustrates a first exemplary proof image sheet, in accordance with an embodiment of the present invention.

FIG. 3 is a flow diagram depicting a method, in accordance with another embodiment of the present invention.

FIG. 4 illustrates a second exemplary proof image sheet, in accordance with a further embodiment of the present invention.

FIG. 5 illustrates a third exemplary proof image sheet, in accordance with still another embodiment of the present invention.

FIG. 6 illustrates a fourth exemplary proof image, in accordance with a further embodiment of the present invention.

FIG. 7 is a flow diagram depicting a method, in accordance with yet another embodiment of the present invention.

### DETAILED DESCRIPTION

Non-limiting embodiments of the present invention provide for methods and systems for managing digital “send jobs” from a digital sender device. A digital “send job” includes digitally scanned images or files that are addressed to one or more destinations. According to an embodiment of the present invention, managing digital send jobs includes generating a “proof image” or “proof images” that are printed for preview prior to sending the image to a destination.

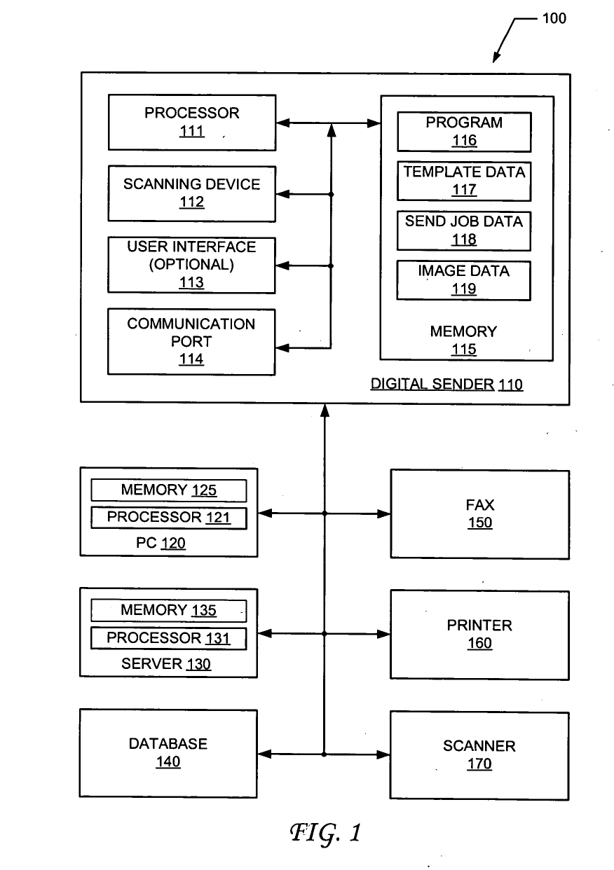

FIG. 1 is a block diagram of a networked digital sender system, illustrating an exemplary operating environment for an embodiment of the present invention. FIG. 1 illustrates a digital sender system 100 for managing digital send jobs from a digital sender device 110. FIG. 1 shows a digital sender 110 that includes a processor 111, a scanning device 112, an optional user interface 113, a communication port 114, and a memory device 115. The memory device 115 is shown including a program 116, template data 117, send job data 118, and image data 119. The processor 111 is further shown enabled for bidirectional communication with scanner device 112, user interface 113, communication port 114, and memory device 115.

FIG. 1 also shows a personal computer (PC) 120, a server 130, a database 140, a facsimile machine 150, a printer 160, and a scanner 170. Personal computer 126 is shown including memory 125, and a processor 121. Server computer 130 is also shown including memory 135, and a processor 131. Digital sender 110 is further shown enabled for bidirectional communication with various devices over a communication interface including personal computer 120, server 130, database 140, facsimile machine 150, printer 160, and scanner 170 through communication port 114. The depicted connections between digital sender 110 and other devices illustrate a network; that is, each device of digital sender system 100 has a unique device identification and network address. Additionally, a device such as personal computer 120 or server computer 130 is enabled to access additional destination addresses such as, for example, e-mail addresses, that can be directly attributable to the unique identification of a device accessing the address, but nonetheless represent unique destinations.

Digital sender 110 is any device configurable for sending digital images and image data to an electronically addressable destination, such as, for example, an e-mail address. In an embodiment, digital sender 110 is a digital sending device such as a multi-function peripheral device, a facsimile machine, a communication-enabled printing and scanning device, or a communication-enabled scanning device.

Processor 111 is any microprocessor, microcontroller, application-specific integrated circuit (ASIC), or combination of the recited components, configured to execute computer instructions. In an embodiment, processor 111 includes memory for caching data, and performing digital signal processing, such as, for example, image processing algorithms. Memory device 115 includes volatile or non-volatile computer readable memory, such as, for example, random access memory (RAM), flash memory and the like. In an embodiment, processor 111 is configured to execute instructions from one or more programs 116 stored in memory 115, and to manipulate digital data such as template data 117, send job data 118, and image data 119.

Program 116 includes one or more computer executable instruction sets that perform functions, such as, for example, controlling scan operations, generating proof images and digital send jobs, optical character recognition (OCR), managing conversion and image manipulation of file formats (e.g., PDF, JPEG, GIF, TIFF, etc.), and managing communication with other devices.

Scanning device 112 includes any digital scanning apparatus configured to generate a digitized image of a document. Digital scanning mechanisms are well known to the skilled practitioner and will not be further discussed.

Optional user interface 113 is an arrangement of data-entry and display devices configured to receive user input to digital sender 110. In an embodiment, user interface 113 includes an alphanumeric key pad and an alphanumeric display suitable for receiving and displaying email addresses, indicating a number of scanned images in a scan job and other data.

Communication port 114 includes one or more communication, interfaces configured to provide signal and data input and output to digital sender 110. In an embodiment, communication port. 114 includes interfaces such as, for example, a telephone modem, a wireless access point adhering to one or more protocols, such as IEEE 802.11 and the so-called “Bluetooth” protocols, a network interface card, a direct cable interface such as PCI or EIO, a Universal Serial Bus card (USB), an optical port operating in the ultra-violet or infra-red range, and the like. In another embodiment, communication port 114 is a gateway for a local area network (LAN) or a wide area network (WAN) that couples many devices within a geographic zone, such as for example, a business computer network operating within one or more buildings. A communication-enabled device is a device that incorporates a communication gateway, such as communication port 114, having one or more communication interfaces as described above.

Personal computer 120 is any communication-enabled computer system having a memory component 125 and a processor 121. In an embodiment, memory component 125 includes programs and data (not shown) such as, for example, an operating system, as will be known to those skilled in the art. In another embodiment (not shown), memory component 125 includes data such as that stored to memory device 115; that is, programs and template, send job, and image data. In operation, a digital sender sends images and data to a recipient, such as, personal computer 120. In an embodiment, images and data are stored to memory 125. The skilled practitioner will recognize that in some implementations personal computer 120 includes other components not relevant to the present discussion and therefore do not require elaboration.

Server computer 130 is any communication-enabled computer system having a memory component 135 and a processor 131. In an embodiment, memory component 135 includes programs and data (not shown) such as, for example, server side programs, as will be known to those skilled in the art. In another embodiment (not shown), memory component 135 includes data such as that stored to memory device 115; that is, programs and template, send job, and image data. In operation, a digital sender sends images and data to a recipient, such as, server computer 130. In an embodiment, the images and data are stored to memory 135. In another embodiment, server computer 130 includes a mass storage device (not shown). In another embodiment, images, send job and template data stored to a mass storage device in server 130 are accessible by another network-connected device, such as for example, digital sender 110. The skilled practitioner will recognize that, in some implementations, server computer 130 includes other components not relevant to the present discussion that will therefore not be discussed.

Database 140 is any communication-enabled mass storage device containing a database. In an embodiment, database 140 is a relational database having entries that correspond to specific addressable accounts, such as for example, email addresses and the like. In another embodiment, database 140 includes data files containing images, template data, and send job data corresponding to one or more network-connected devices.

Facsimile machine 150 is any facsimile (fax) machine. In an embodiment (not shown), facsimile machine 150 includes a mechanism for digitally scanning documents, a processor, a communication port, and one or more memory components. In an embodiment, facsimile machine 150 is enabled to operate as a document copying device. The configuration and operation of facsimile machines is well known to those skilled in the art, and therefore will not be further discussed.

Printer 160 is any communication-enabled printing device configured for rendering images and documents, such as proof images, from data files onto tangible media, such as, for example, paper sheet stock. In an embodiment, printer 160 is a multi-function printer-scanner device enabled to operate as a document copying and sending device. In one embodiment (not- shown), printer 160 includes a processor and memory components. In another embodiment, a digital sender can be designated by a network administrator to default to specific network connected printers for printing of proof image documents based on the destination printer's capabilities. In yet another embodiment, the digital sender is enabled to “browse” the network for printers having required printing capabilities, such as for example, oversize sheets or color printing. The configuration and operation of printing devices will be known to the skilled practitioner, and therefore will not be discussed in further detail.

Scanner 170 is any communication-enabled scanning device configured to generate image files. In an embodiment, scanner 170 includes digital, analog or both scanning hardware that is configured to create image data files of media that are located proximate to the scanning hardware. In an embodiment (not shown), scanner 170 includes a processor and memory components. In another embodiment, scanner 170 incorporates an alphanumeric keypad and an alphanumeric display. The configuration and operation of scanning devices will be known to the skilled practitioner, and therefore will not be discussed in further detail.

In another embodiment, two or more of the above described communication-enabled devices are combined or configured to operate as a single unit, such as, for example, a multi-function peripheral device, and a communication-enabled printing and scanning device.

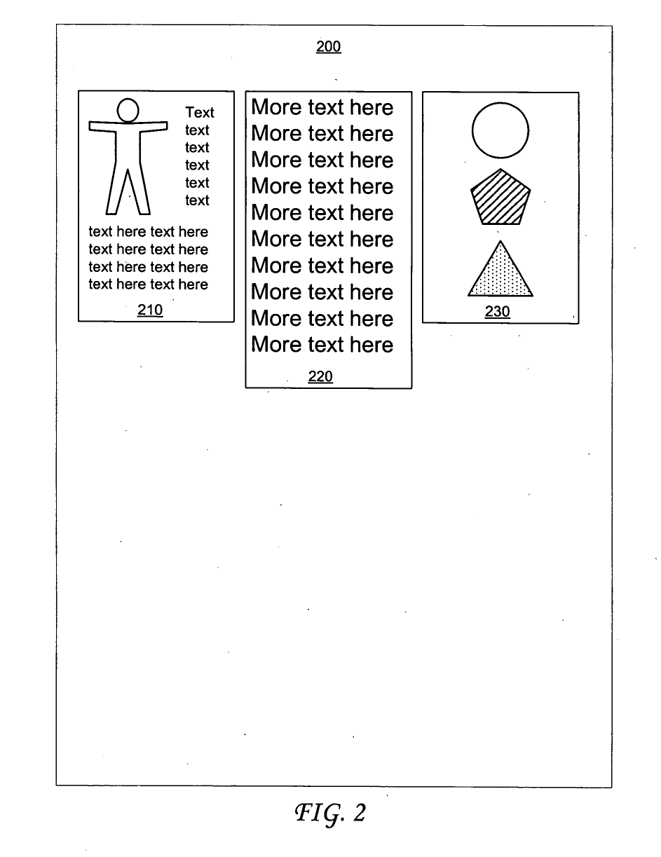

FIG. 2 illustrates a first exemplary proof image sheet, in accordance with an embodiment of the present invention. FIG. 2 shows graphical representation of a printed proof image sheet 200 having three “thumbnail” preview images 210, 220, 230 of a digital scan job. Proof image sheet 200 can be printed in black and white, grayscale, or color, on any suitable media, such as, for example, paper sheet stock, and in any suitable size, depending on the application. In the following discussion, a “proof image” is generally a graphic image embodied in an electronic data file in a memory device, such as for example, a scanned image or a scanned image combined with other image data stored or cached in memory. A “proof image sheet” or “proof sheet” is generally a physical manifestation of a “proof image”, whether displayed to a graphical user interface or printed to a fixed media.

Proof sheet 200 is illustrative of a digital scan job having three separately scanned images or original documents. The first preview image 210 includes text and graphic content, with an image size based on a letter sized (8.5 by 11 inch) original document. The second preview image 220 includes text, with an image size based on a legal sized (8.5 by 14 inch) original document. The third preview image includes graphical content, with an image size based on a letter sized original document.

As shown in FIG. 2, proof image sheet 200 represents a letter sized proof sheet. However, in some implementations, scanned images will have different sizes than those illustrated and proof image sheets will have selectable dimensions depending on the original documents and proof image sheet configuration. In another embodiment (not shown), each thumbnail preview image of proof image sheet 200 includes text identification, such as, for example, an image number, original image size, send job destination information and the like. In yet another embodiment, the size of preview images on a proof image sheet is dynamically determined based on the number of images in a scan job, and the number of proof sheets either specified by a user, or based on the media available at a printer. In still another embodiment, proof image sheet 200 is a full size reproduction of a scanned original document.

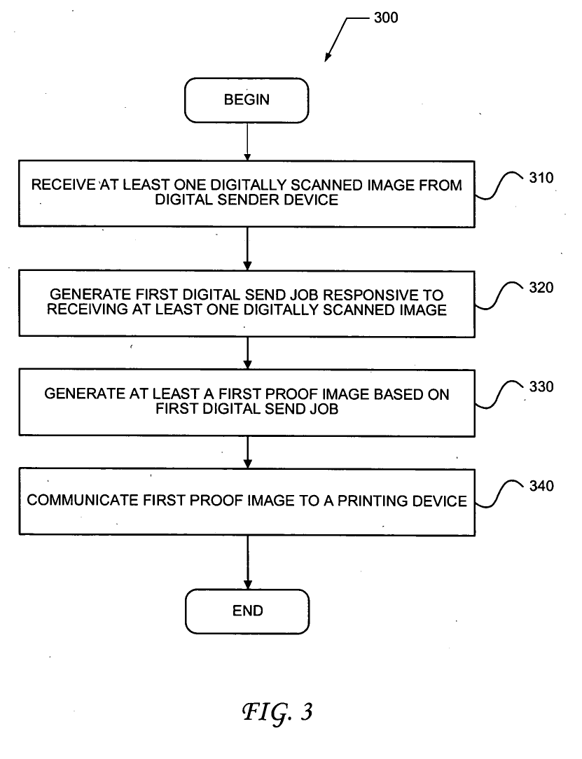

FIG. 3 is a flow diagram depicting a method 300, in accordance with another embodiment of the present invention. FIG. 3 illustrates a method 300 of managing digital send jobs from a digital sender device. In one embodiment, method 300 is implemented with components of the exemplary system of FIG. 1 and the graphical representations described with reference to FIG. 2. In another embodiment, one or more steps of method 300 are embodied in a computer readable medium containing computer readable code such that a series of steps are implemented when the computer readable code is executed on a computing device. Method 300 begins in step 310. Various steps of the method 300 are described with respect to a digital sender performing the method. In some implementations, certain steps of method 300 are combined, performed simultaneously or in a different order, without deviating from the objective of method 300 or producing different results.

In step 310, at least one digitally scanned image is received from a digital sender device. The digitally scanned image is received at any time after a digital imaging device creates a digital image data file during a scanning or image capture operation. In an embodiment, the digital image file is received from a digital scanning device within a digital sender, such as scanning device 112 of digital sender 110 described with reference to FIG. 1. In another embodiment, the digital image file is received from a remote device coupled to a network, such as, for example, facsimile machine 150, and scanner 170 of FIG. 1. The digital image file is in a suitable image file format (e.g., PDF, JPEG, GIF, TIFF, etc.) for reception and manipulation by a program executing on a processor.

In step 320 (FIG. 3), a first digital send job is generated responsive to receiving at least one digitally scanned image. The first digital send job is generated at any time after a digitally scanned image or image data file is received. In an embodiment, the first digital send job is generated by one or more computer programs executed by a processor. In another embodiment, the first digital send job is stored to a memory device after generation.

In step 330, a first proof image is generated based on the first digital send job. In an embodiment, the first proof image is generated at any time after a digital send job is created. In another embodiment, the first proof image is generated by one or more computer programs executed by a processor. In yet another embodiment, the order for performing steps 320 and 330 is interchanged such that a first proof image is generated responsive to receiving a first digitally scanned image, and a digital send job is generated based on the first proof image. In still another embodiment, generating a first proof image based on the first digital send job includes receiving a user request from a user interface to generate the first proof image of the multi-function peripheral device and producing the first proof image based on the first digital send job responsive to the received user request. In another embodiment, the first proof image is stored to a memory device after generation. Image processing techniques for the generation of proof images are known to the skilled practitioner and will not be further discussed.

In step 340, the first proof image is communicated to a printing device. The first proof image is communicated to a printing device at any time after the proof image is generated. In one embodiment, the first proof image is communicated to a communication-enabled printing device through a network such as printer 160 of FIG. 1. An example of method 300 as implemented with reference to devices of FIG. 1 and illustrations of FIG. 2 follows. A digital sender 110 receives one or more a digitally scanned images based on one or more original documents from a scanning device 112. The digitally scanned images are stored as image data 119 within a memory device 115. The image data is accessed and processed to generate a digital send job by a processor 111 that executes one or more computer programs 116 stored on the memory device 115. A user interface 113 is employed to receive instructions, destination device addresses and proof sheet document size instructions from a user. A first proof image 200 is generated based on the send job. The first proof image includes one or more “thumbnail” or full size preview images 210, 220, 230 based on the scanned original documents. The first proof image is sent through a-network-connected communication port 114 of the digital sender 110, to a printing device 160 connected to the network. The network printing device is selected based on the requirements of the proof image, such as color, black and white, grayscale and the like. The printing device 160 then prints the first proof image as a document that may be reviewed by a user to preview the digital send job prior to delivery to a recipient. In other embodiments, the printing of the proof sheet is a selectable feature that is controllable by a network administrator.

Another embodiment includes the further step of producing additional digital send jobs, beginning with a second send job. Additional send jobs, beginning with the second send job, are based on user input where each of the send jobs includes a digital send job identifier. Each additional proof image that is generated based on a corresponding digital send job is associated with the digital send job identifier corresponding to the digital send job from which it is generated. User input that the additional jobs are based on includes a user-modified printed proof image that is digitally scanned subsequent to user modification.

In yet another embodiment, producing additional send jobs, beginning with a second digital send job, includes generating a corresponding proof image, beginning with a second proof image, based on the first proof image and a stored user input template image. The corresponding proof image, beginning with the second proof image includes a digital send job identifier. The next steps of producing additional send jobs, beginning with the second send job, include storing the second proof image and communicating the second proof image to a printing device. Once printed, the proof images can be marked by a user with user input. Next, a third proof image having user input can be received from a digital scanner device. The third proof image can then be processed to determine the digital send job identifier and any user instructions marked on the printed second proof image. The third proof image is associated with the first, or an associated digital send job, based on the digital send job identifier. Finally, a second digital send job can be generated by modifying the identified digital send job based on the determined user instructions.

In still another embodiment, the step of generating the second proof image based on the first proof image and the stored user input template image includes the steps of receiving the first proof image, retrieving the user input template image, and combining the retrieved first proof image and the retrieved user input template image. As described above, FIG. 3 illustrates several embodiments of a method 300 of managing digital send jobs from a digital sender device.

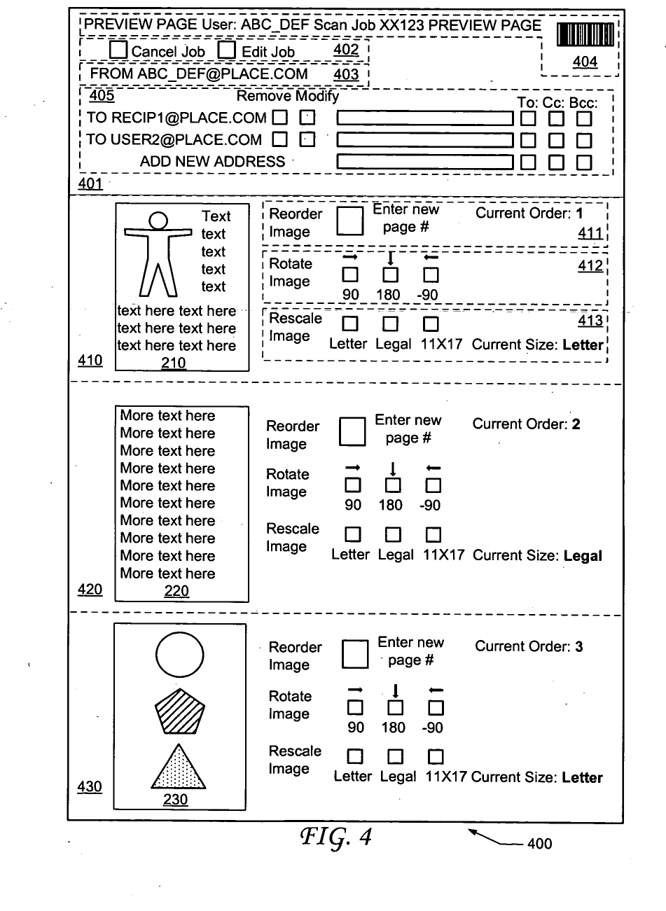

FIG. 4 illustrates a second exemplary proof image sheet, in accordance with a further embodiment of the present invention. FIG. 4, in the manner of FIG. 2, shows a graphical representation of a printed proof image sheet 400 again having the three “thumbnail” preview images 210, 220, 230 of the digital scan job as discussed with reference to FIG. 2. However, proof sheet 400 shows additional information in the form of user input template regions that were not included in proof sheet 200 of FIG. 2. Specific exemplary information and user input template regions within proof sheet 400 are highlighted with dashed lines that are provided to clarify the discussion of various specific template regions, but would not actually appear on a printed proof image sheet. Proof image sheet 400 can be printed in black and white, grayscale or color, on any suitable media, such as, for example, paper sheet stock, and in any suitable size, depending on the requirements of a proof image.

Proof sheet 400 illustrates several template regions. A send job template region 401 includes additional template regions for send job “cancel” and “edit” user input commands 402, a send job identifier 404, send job address origination information 403, and send job destination address information 405. Proof sheet 400 also illustrates “thumbnail” preview image regions 410, 420 and 430 corresponding to each “thumbnail” preview image 210, 220, 230 respectively. Within each of the “thumbnail” preview image regions 410, 420 and 430 is shown information and other user input selection regions. Referring specifically to “thumbnail” preview image region 410, template regions are shown for reordering a scanned image within the send job 411, rotating a scanned image 412, and resealing a scanned image 413. Regions 420 and 430 include identical user input template regions.

Send job identifier region 404 of FIG. 4 illustrates a textual send job identifier in the form of text that reads “PREVIEW PAGE User: ABC_DEF Scan Job XX123 PREVIEW PAGE”. An optically readable bar code send job identifier is also shown in region 404. In one embodiment, the optically readable bar code represents an alphanumeric code associated with textual data printed as a textual send job identifier, such as, according to the prior example, “XX123”. In other embodiments, a send job identifier is any type of visual mark for uniquely identifying a send job, such that a user or a digital scanning apparatus is enabled to make an identification of the send job based on the send job identifier.

Template region 402 of FIG. 4 shows user input selection boxes for send job “cancel” and “edit” commands. For each user selection, a user input box is shown positioned next to a text instruction. A user input selection box on a printed proof sheet 400 can be marked by a user to indicate a user selection and to provide user input.

Template region 403 of FIG. 4 shows send job address origination information. A textual send job origination address in the form of text that reads “FROM ABC_DEF@PLACE.COM” indicates the address of a sending device where the printed proof image originated.

Template region 405 of FIG. 4 shows user input selection boxes and destination address information. Template region 405 illustrates two textual send job destination descriptions that read “TO RECIP1@PLACE.COM” and “TO USER2@PLACE.COM”, and textual description to prompt user input that reads “ADD NEW ADDRESS”. For each above textual descriptions, a user input box is shown positioned next to a text instruction for user input selections and commands such as “remove,” “modify,” “To:,” “Cc:,” and Bcc:”. Furthermore, an elongated user input selection box (not numbered) is positioned next to each textual description to allow user input of new or changed send job destination address text.

As discussed above, template region 410 of FIG. 4 shows template regions for reordering a scanned image within the send job 411, rotating a scanned image 412, and resealing a scanned image 413. Template region 411 shows a user input selection box positioned between the text “Reorder Image” and “Enter new Page #”. A textual indication of the present order of the image 210 within the send job is also illustrated in template region 411 as “Current Order: 1”. Template region 412 shows three user input selection boxes positioned next to the text “Rotate Image.” A textual indication of “90”, “180” and “−90” is positioned directly below the three user input selection boxes respectively to indicate a user input selection for degrees of rotation in image position relative to the current image position. Template region 413 shows three user input selection boxes positioned next to the text “Rescale Image.” A textual indication of “Letter”, “Legal” and “11×17” is positioned directly below the three user input selection boxes, respectively, to indicate a user input selection for image size. A textual indication of the present size of the image 210 is also illustrated in template region 413 as “Current Size: Letter”. In the above manner, various send job information and user input templates are combined in a proof image sheet 400 in order to present a preview of a digital send job and to allow modification a digital send job from a digital sending device.

In an embodiment, user input template regions 401, 410, 420, and 430 are dynamically configurable depending upon desired template content and user input selections. In another embodiment, user input template selections and configuration data is received to a user interface, such as, for example, an alphanumeric keypad. In the above manner, a user selects the type and content of user input templates that will be combined with scanned images to generate a proof image sheet.

As described above, FIG. 4 illustrates several embodiments of a graphical representation of a printed proof image sheet 400 that includes user input template regions 401, 410, 420, and 430. The exemplary embodiments of user input template regions shown in FIG. 4 are merely illustrative and many other user input template options are possible.

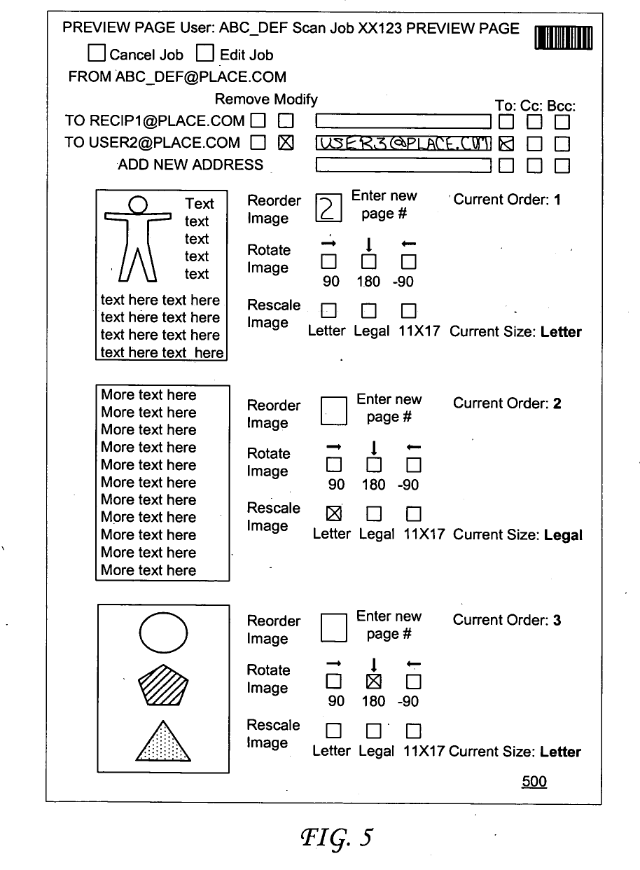

FIG. 5 illustrates a third exemplary proof image sheet, in accordance with still another embodiment of the present invention. FIG. 5 shows an illustration of the printed proof image sheet of FIG. 4 as it would appear having user input 500. Referring to the discussion of FIG. 4, user input is indicated (in FIG. 5) in the template region 405 of FIG. 4, where the destination address “USER2@PLACE.COM” is selected to be modified by a mark in the-user input selection box having the label “Modify”. A new destination address is provided in the user input box next to old destination address that reads USER3@PLACE.COM. A mark in the box labeled “To:” indicates that the new user-entered address is selected as a replacement send job destination.

Again referring to the discussion of FIG. 4, user input is also indicated (in FIG. 5) in the template region 411 of FIG. 4, where the order of the image in the send job is selected to be changed by the text “2” provided in the user input selection box labeled “Enter new page #”. It is worth noting that the order of the image within the send job is reported to be “1” according to text in region corresponding to 410 of printed proof image 500.

Once again referring back to FIG. 4, user input is indicated (in FIG. 5) in a template region identical to that of region 413, but for “thumbnail” preview image region 420. A change in the image scale to “letter” is indicated by a mark in the user input selection box labeled “Letter” that is associated with the text “Rescale Image”. It is worth noting that the image size is reported to be “Legal”, according to text in region corresponding to 420 of printed proof image 500.

Referring back to FIG. 4 another time, user input is indicated (in FIG. 5) in a template region identical to that of region 412, but corresponding to thumbnail” preview image region 430. A change in the image rotation is indicated by a mark in the user input selection box labeled “180” that is associated with the text “Rotate Image”.

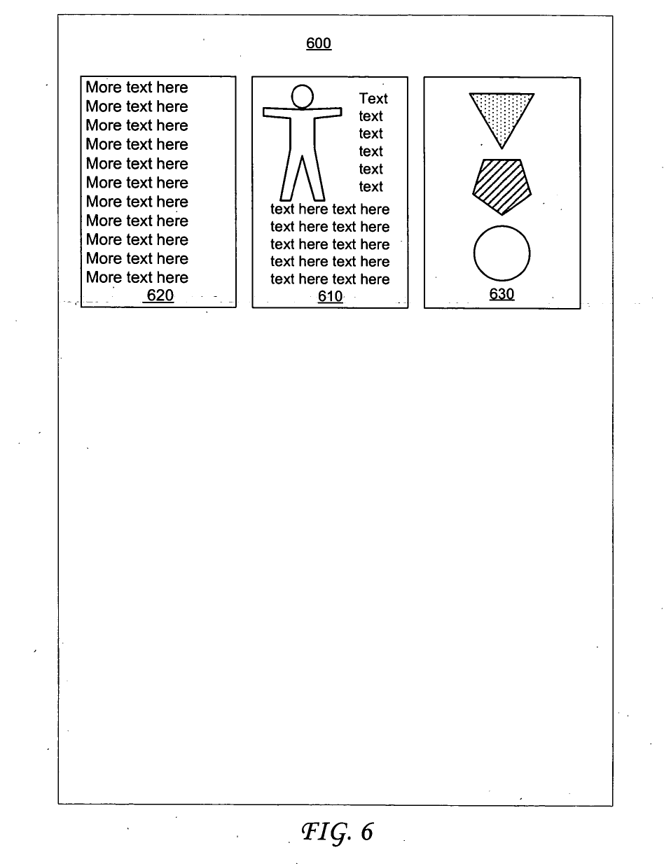

FIG. 6 illustrates a fourth exemplary proof image, in accordance with a further embodiment of the present invention. FIG. 6 is an illustration of a printed image proof sheet 600 incorporating the user input selections discussed with reference to FIG. 5. Three “thumbnail” preview images are shown in FIG. 6 that correspond to a modified digital send job that includes the three scanned images 210, 220, and 230 as discussed with reference to FIGS. 2,4 and 5. However, in FIG. 6, the scanned images 610, 620, and 630 have been modified based on the user input selections described in FIG. 5. The first scanned image 620 corresponds to scanned image 220, but image 620 is now scaled to “letter” size from its original “legal” size. Image 610 corresponds to image 210, but image 610 is now placed second in the send job order. Image 630 corresponds to image 230, but is now shown rotated 180 degrees with respect to image 230.

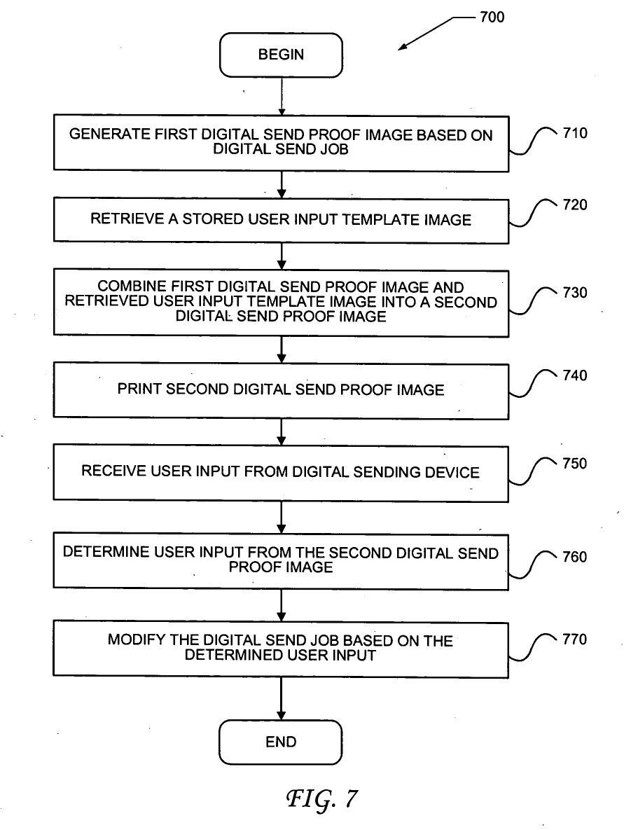

FIG. 7 is a flow diagram depicting a method, in accordance with yet another embodiment of the present invention. FIG. 7 illustrates a method 700 of modifying a digital send job based on user input to a digital sending device. In one embodiment, method 700 is implemented with components of the exemplary system of FIG. 1 and the graphical representations described with reference to FIG. 2. In another embodiment, one or more steps of method 700 are embodied in a computer readable medium containing computer readable code such that a series of steps are implemented when the computer readable code is executed on a computing device. Method 700 begins in step 710. Various steps of the method 700 are described with respect to a digital sender performing the method. In some implementations, certain steps of method 700 are combined, performed simultaneously or in a different order, without deviating from the objective of method 700 or producing different results. In the following discussion, a “send proof image” is generally a graphic image embodied in an electronic data file in a memory device, such as for example, a scanned image or a scanned image combined with other image data stored or cached in memory. A physical manifestation of a “send proof image” includes a “send proof image” displayed to a graphical user interface display device or printed to a fixed medium.

In step 710, a first digital send proof image is generated based on a digital send job. In one embodiment, the first digital send proof generation is initiated by a user when the user desires modification of a pre-existing digital send job. In an embodiment, the first digital send proof image is generated by one or more computer programs executed by a processor. Image processing techniques for the generation and manipulation of proof images are known to the skilled practitioner and will not be further discussed. In another embodiment, the first digital send proof image is stored to a memory device after generation. In yet another embodiment, each pre-existing digital send job has a unique send job identifier that is associated with each digital send proof image corresponding to the digital send job.

In step 720, a stored user input template image is retrieved. In one embodiment, a user input template image is retrieved at any time after a first send proof image is generated. In another embodiment, a plurality of user input templates are stored in a memory. In still another embodiment, retrieving the user input template image includes the steps of receiving user template selections from a user interface of the digital sending device and dynamically configuring a user input template file based on the received user template selections.

In step 730, the first digital send proof image and the retrieved user input template image are combined into a second digital send proof image. In an embodiment, the first digital send proof image and the retrieved user input template image are combined at any time after the user input template image is retrieved from a memory. In an embodiment, various imaging software is employed to combine the first digital send proof image and the retrieved user input template image.

In step 740, the second digital send proof image is printed. In an embodiment, the second digital send proof image is printed at any time after the completion of step 730. In another embodiment, a printing device compatible with the second digital send proof image is identified that is within a network coupled to the digital sending device, and then the second digital send proof image is communicated to the identified printing device. Printer compatibility with the second digital send proof includes considerations such as proof image size, whether the proof image is to be printed in black and white, grayscale or color, and the type of media that the proof image is to be printed on such as, for example, paper sheet stock, and the like. In another embodiment, the digital sender is a multi-function peripheral device with built in printing capability, and the second digital send proof image is printed at the digital sender.

In step 750, user input is received from the digital sending device. In an embodiment, the printed second digital send proof image is scanned subsequent to incorporation of user input on the printed second digital send proof image. In another embodiment, the user input is received at any time after the scanning of a printed second digital send proof sheet incorporating user input selections.

In step 760, user input is determined from the received second digital send proof image. In an embodiment, the received second digital send proof image is provided to a user input recognition system and the user input recognition system is implemented to detect user-provided parameters within the received second digital send proof image. In one embodiment, an optical character recognition system is implemented to detect the user-provided parameters. In another embodiment, the user input from the second digital send-proof image is determined at any time after activation of a user input recognition system.

In step 770, the digital send job is modified based on the determined user input. In an embodiment, the digital send job is modified at any time after the user input is received. In another embodiment, the modified send job has a different send job identifier. In yet another embodiment, the send-job is modified based on user provided parameters, such as send job destinations, digital send proof image orientation, digital send proof image size, and digital send proof image order.

An example of method 700 as implemented with reference to devices of FIG. 1 and illustrations of FIGS. 2, 4, 5, and 6 follows. A digital sender 110, or another connected device, stores one or more digital send jobs based on digitally scanned images of original documents. The digital send jobs are stored as send job data 118 and image data 119 within a memory device 115. The send job data 118 is accessed and processed to generate a first digital send proof image by a processor 111 that executes one or more computer programs 116 stored on the memory device 115. User input template images, stored as template data 117, are retrieved from a memory device 115 and then combined with a digital send proof images to generate a second digital send proof image that is stored as image data 119. In one implementation, a user interface 113 is employed to receive user template selections from a user interface of a digital sending device. A user input template file is then configured based on the received user template selections. The second digital send proof image is then sent to a printer device 160. In one implementation, a network printer 160 is first identified that is compatible with the second digital send proof image and then the second proof image is communicated to the identified printing device 160. The user input 500 is then determined from the received second digital send proof image by providing the received second digital send image to a user input recognition system 116 stored in memory 115 and implementing the user input recognition system 116 to detect user provided parameters within the received second digital send proof image 500. The digital send job is then modified according to the user input determined from the user input recognition system. As described above, FIG. 7 illustrates several embodiments of a method 700 for modifying a digital send job based on user input to a digital sending device.

It is anticipated that the invention will be embodied in other specific forms, not specifically described, that do not depart from its spirit or essential characteristics. The described embodiments are to be considered in all respects only as illustrative and not restrictive.

1. A method of managing digital send jobs from a digital sender device, comprising:
receiving at least one digitally scanned image from a digital sender device;
generating a first digital send job responsive to receiving the at least one digitally scanned image;
generating at least a first proof image based on the first digital send job; and
communicating the first proof image to a printing device.

2. The method of claim 1, and wherein generating at least a first proof image based on the first digital send job comprises:
receiving a user request from a user interface to generate the first proof image of the multi-function peripheral device; and
producing the first proof image based on the first digital send job responsive to the received user request.

3. The method of claim 1, and further comprising:
producing at least a second digital send job based on a user input wherein each send job includes a digital send job identifier; and,
wherein each proof image is associated with a corresponding digital send job identifier; and,
wherein the user input is a user modified printed second proof image that is digitally scanned subsequent to the modification.

4. The method of claim 3, and wherein producing the second digital send job comprises:
generating a second proof image based on the first proof image and a stored user input template image, wherein the second proof image includes a digital send job identifier;
storing the second proof image;
communicating the second proof image to a printing device;
receiving a third proof image having user input from a digital scanner device;
processing the received third proof image to determine user instructions and the digital send job identifier;
associating the third proof image with the first digital send job based on the digital send job identifier; and
generating the second digital send job by modifying the identified digital send job based on the determined user instructions.

5. The method of claim 4, and wherein generating the second proof image based on the first proof image and the stored user input template image comprises:
receiving the first proof image;
retrieving the user input template image; and
combining the retrieved first proof image and the retrieved user input template image.

6. The method of claim 1, and wherein the digital sending device is selected from the group consisting of:
a multi-function peripheral device, a facsimile machine, a communication-enabled printing and scanning device, and a communication-enabled scanning device.

7. A method of modifying a digital send job based on user input to a digital sending device, comprising:
generating a first digital send proof image based on a digital send job;
retrieving a stored user input template image;
combining the first digital send proof image and the retrieved user input template image into a second digital send proof image;
printing the second digital send proof image;
receiving the user input from the digital sending device wherein the second digital send proof image is scanned subsequent to incorporation of user input on the printed second digital send proof image;
determining the user input from the second digital send proof image; and
modifying the digital send job based on the determined user input.

8. The method of claim 7, and wherein each digital send job has a unique send job identifier that is associated with each digital send proof image corresponding to the digital send job.

9. The method of claim 7, and wherein retrieving the user input template image comprises:
receiving user template selections from a user interface of the digital sending device; and
configuring a user input template file based on the received user template selections.

10. The method of claim 7, and wherein printing the second digital send proof image comprises:
identifying a printing device compatible with the second digital send proof image that is within a network coupled to the digital sending device; and
communicating the second digital send proof image to the identified printing device.

11. The method of claim 7, and wherein determining the user input from the received second digital send proof image comprises:
providing the received second digital send proof image to a user input recognition system; and
implementing the user input recognition system to detect user provided parameters within the received second digital send proof image.

12. The method of claim 11, and wherein the send job is modified based on user provided parameters selected from the group consisting of:
one or more send job destinations, digital send proof image orientation, digital send proof image size, and digital send proof image order.

13. The method of claim 7, and wherein the digital sending device is selected from the group consisting of:
a multi-function peripheral device, a facsimile machine, a communication-enabled printing and scanning device and a communication-enabled scanning device.

14. A computer readable medium storing a computer program to manage digital send jobs from a multi-function peripheral device, the program comprising:
computer readable code to direct the reception of at least one digitally scanned image from the digital sender device;
computer readable code to generate a first digital send job responsive to receiving at least one digitally scanned image;
computer readable code to generate at least a first proof image based on the first digital send job; and
computer readable code to communicate the first proof image to a printing device.

15. The computer readable medium of claim 14, and wherein computer readable code to generate a first proof image based on the first digital send job comprises:
computer readable code to direct the reception of a user request from a user interface to generate the first proof image of the multi-function peripheral device; and
computer readable code to produce the first proof image based on the first digital send job responsive to the received user request.

16. The computer readable medium of claim 14, and further comprising:
computer readable code to produce at least a second digital send job based on a user input wherein each send job includes a digital send job identifier; and,
wherein each proof image is associated with a corresponding digital send job identifier; and,
wherein the user input is a user modified printed second proof image that is digitally scanned subsequent to the modification.

17. The computer readable medium of claim 15, and wherein computer readable code to produce the second digital send job comprises:
computer readable code to generate a second proof image based on the first proof image and a stored user input template image, wherein the second proof image includes a digital send job identifier;
computer readable code to store the second proof image;
computer readable code to communicate the second proof image to a printing device;
computer readable code to direct the reception of a third proof image having user input from a digital scanner device;
computer readable code to process the received third proof image to determine user instructions and the digital send job identifier;
computer readable code to associate the third proof image with the first digital send job based on the digital send job identifier; and
computer readable code to generate the second digital send job by modifying the identified digital send job based on the determined user instructions.

18. The computer readable medium of claim 15, and wherein computer readable code for generating the second proof image based on the first proof image and the stored user input template image comprises:
computer readable code to receive the first proof image,
computer readable code to retrieve the user input template image; and
computer readable code to combine the retrieved first proof image and the retrieved user input template image.

19. A scanner configured to operate as a user interface for modifying digital send jobs, comprising:
a digital scanning device including;
a communication interface,
a digital scanning apparatus,
a processor, and;
a computer readable memory device which is readable by the processor, the computer readable memory device containing a series of computer executable steps configured to cause the processor to;
receive at least one digitally scanned image from the digital scanning apparatus,
generate a first digital send job responsive to receiving the at least one digitally scanned image,
generate at least a first proof image based on the first digital send job, and,
communicate the first proof image to a printing device through the communication interface.

20. The scanner of claim 19, and wherein the computer executable steps are further configured to cause the processor to:
produce at least a second digital send job based on a user input wherein each send job includes a digital send job identifier; and,
wherein each proof image is associated with a corresponding digital send job identifier; and,
wherein the user input is a user modified printed second proof image that is digitally scanned subsequent to the modification.

21. The scanner of claim 19, and wherein the series of computer executable steps configured to cause the processor to produce the second digital send job comprise a series of computer executable steps configured to cause the processor to:
generate a second proof image based on the first proof image and a stored user input template image, wherein the second proof image includes a digital send job identifier;
store the second proof image;
communicate the second proof image to a printing device;
receive a third proof image having user input from a digital scanner device;
process the received third proof image to determine user instructions and the digital send job identifier;
associate the third proof image with the first digital send job based on the digital send job identifier; and
generate the second digital send job by modifying the identified digital send job based on the determined user instructions.

22. The scanner of claim 19, and wherein the computer executable steps configured to cause the processor to generate the second proof image based on the first proof image and the stored user input template image comprise a series of computer executable steps configured to cause the processor to:
receive the first proof image;
retrieve the user input template image; and
combine the retrieved first proof image and the retrieved user input template image.

23. The scanner of claim 19, and wherein the scanner is selected from the group consisting of:
a facsimile machine, a communication-enabled multi-function printer scanner device and a communication-enabled digital scanning and sending device.

24. The scanner of claim 19, and wherein the processor and the computer readable memory device are resident within a network.

25. A system to manage digital send jobs for a multi-function peripheral device, comprising:
a network including;
at least one printing means, and;
at least one scanner configured to operate as a user interface for modifying digital send jobs, the scanner including;
communication interface means,
digital scanning means,
processing means, and,
computer readable memory means which is readable by the processing means, the computer readable memory means containing a series of computer executable steps configured to cause the processing means to;
receive at least one digitally scanned image from the digital scanning means,
generate a first digital send job responsive to receiving the at least one digitally scanned image,
generate at least a first proof image based on the first digital send job, and,
communicate the first proof image to the printing means through the communication interface means.

26. The system of claim 25 wherein the scanner further comprises user interface means and wherein the computer executable steps configured to cause the processing means to generate at least a first proof image based on the first digital send job comprise a series of computer executable steps configured to cause the processing means to:
receive a user request from the user interface means to generate the first proof image of the multi-function peripheral device; and
produce the first proof image based on the first digital send job responsive to the received user request.

27. The system of claim 25, and wherein the series of computer executable steps are further configured to:
produce at least a second digital send job based on a user input wherein each send job includes a digital send job identifier; and,
wherein each proof image is associated with a corresponding digital send job identifier; and
wherein the user input is a user modified printed second proof image that is digitally scanned subsequent to the modification.

28. The system of claim 25, and wherein the series of computer executable steps configured to produce at least a second digital send job based on a user input wherein each send job includes a digital send job identifier comprise computer executable steps configured to cause the processing means to:
generate a second proof image based on the first proof image and a stored user input template image, wherein the second proof image includes a digital send job identifier;
store the second proof image;
communicate the second proof image to a printing device;
receive a third proof image having user input from a digital scanner device;
process the received third proof image to determine user instructions and the digital send job identifier;
associate the third proof image with the first digital send job based on the digital send job identifier; and,
generate the second digital send job by modifying the identified digital send job based on the determined user instructions.

29. The system of claim 25, and wherein the series of computer executable steps configured to generating the second proof image based on the first proof image and the stored user input template image comprise computer executable steps configured to cause the processing means to:
receive the first proof image;
retrieve the user input template image from the memory means; and
combining the retrieved first proof image and the retrieved user input template image.
